(19) United States
(12) Patent Application Publication
(10) Pub. No.: US 2019/0137289 A1
(43) Pub. Date: May 9, 2019

(54) Detection of Map Anomalies

(71) Applicant: Uber Technologies, Inc., San Francisco, CA (US)

(72) Inventors: Sundar Annamalai, Mountain View, CA (US); Naomi Chopra, Haryana (IN)

(21) Appl. No.: 16/183,630

(22) Filed: Nov. 7, 2018

(30) Foreign Application Priority Data
Nov. 7, 2017 (IN) 201741039669

(51) Int. Cl. G01C 21/34; G06F 17/30; G01C 21/20; G05D 1/02

(52) U.S. Cl. CPC G01C 21/3415; G06F 17/30241; G05D 2201/0213; G05D 1/0212; G01C 21/20

(57) ABSTRACT

To identify erroneous digital map data, a route guidance engine provides guidance from a first point to a second point along a road network using data stored in a map database. The route guidance engine determines whether a vehicle travels the recommended route or a different route. A map anomaly detection (MAD) engine compares the trace data to the recommended route data. The MAD engine identifies points along the recommended route not included in the trace and points along the trace not included in the recommended route. From this data, the MAD engine identifies section pairs and performs a filtering step. The MAD engine aggregates data for all trips from the first point to the second point within a particular period, and aggregates all trips from all starting points to ending points. The resulting set of points are points where the stored map data is likely incorrect.

### CROSS-REFERENCE TO RELATED APPLICATIONS

This application claims priority to and the benefit of Indian Provisional Application 201741039669, filed on Nov. 7, 2017, which is incorporated by reference herein in its entirety.

### BACKGROUND

### Field

The described embodiments relate generally to detecting errors in digital maps, and more specifically to inferring the existence of erroneous map data based on analysis of actual vehicle trace data.

### Description of Related Art

Digital maps are used for a variety of functions, including providing navigation assistance to drivers and riders.

Inaccuracies often exist in digital map data. For example, data may have been collected incorrectly, and is thus represented incorrectly in the map. Or, changes in the road network may have occurred since the map data was collected, for example because of construction of new roads, closure of existing roads, or addition and removal of traffic flow restrictions.

Inaccurate map data inhibits the ability to provide efficient navigation routing to drivers and vehicles, and can create a safety hazard.

### SUMMARY

Described embodiments enable the identification of erroneous digital map data. A route guidance engine provides guidance from a first point to a second point along a road network, using data stored in a map database. The route guidance engine determines, for each recommended route, whether a vehicle actually travels the recommended route, or instead travels a different route from the first to the second point.

A map anomaly detection (MAD) engine compares the trace data (that is, the data showing the actual path traveled by the vehicle) to the recommended route data for a particular trip from the first point to the second point. The MAD engine identifies points along the recommended route that are not included in the trace. The MAD engine also identifies points along the trace that are not included in the recommended route. From these two data sets, the MAD engine identifies section pairs—that is, nearby segments of the recommended route polyline and the trace polyline—and then performs a filtering step to reduce false positives and false negatives.

The MAD engine then aggregates data for all trips from the first point to the second point within a particular time period of interest, and further aggregates all trips from all starting points to ending points. The resulting set of points, or a most-frequently occurring set of points, are points where the stored map data is likely incorrect.

In some embodiments, the MAD engine can automatically correct the map data, for example by inferring the existence of a road segment, the non-existence of a road segment, or the existence or lack thereof of a turn restriction. In various embodiments, the set of points can be used to identify and correct map data errors in a significantly more efficient manner than is conventionally required.

### BRIEF DESCRIPTION OF THE DRAWINGS

FIG. 1 illustrates a system for identifying anomalies in map data in accordance with one embodiment.

FIG. 2 is a flowchart illustrating steps for providing recommended route guidance to a requester in accordance with one embodiment.

FIG. 3 is a flowchart illustrating a method for identifying anomalies in map data in accordance with one embodiment.

FIG. 4 illustrates an example of a polyline before and after interpolation in accordance with one embodiment.

FIG. 5 illustrates the identification of points that are present on only one of a trace route polyline and a recommended route polyline in accordance with one embodiment.

FIGS. 6A, 6B, and 6C illustrate example section pairs of polyline segments that are discarded in accordance with one embodiment.

FIG. 7 illustrates a section pair of polyline segments that are evaluated according to one embodiment.

FIG. 8 illustrates locations of potentially erroneous map data in accordance with one embodiment.

FIG. 9 illustrates clustering of potentially erroneous map data locations in accordance with one embodiment.

FIG. 10 is a diagram illustrating an example of a computer system upon which described embodiments may be implemented.

### DETAILED DESCRIPTION

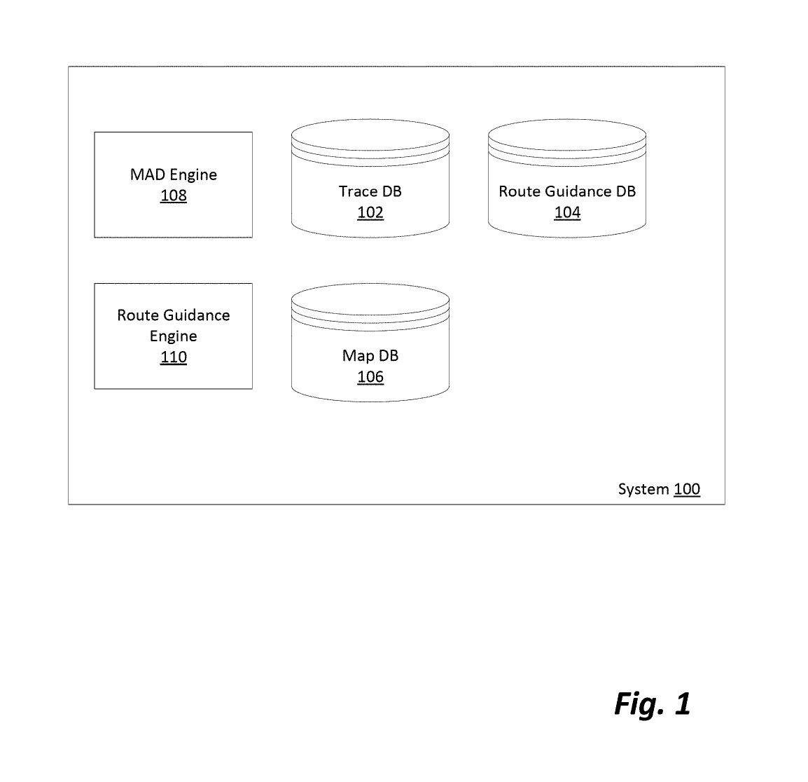

FIG. 1 illustrates a system 100 for identifying anomalies in map data in accordance with one embodiment. System 100 includes route guidance engine 110, map database 106, trace database 102, route guidance database 104, and map anomaly detection (MAD) engine 108.

Map database 106 includes map data for a geographic region. Map data includes a road network and attributes of the network, such as how road segments are connected to one another, and the manner in which segments may be traversed. Route guidance engine 110 receives requests for route guidance, provides recommended route guidance to the requester using data from map database 106, determines the route actually taken, and stores the recommended route and actual traced route in route guidance database 104 and trace database 102, respectively. Trace data may be collected, for example, using an in-vehicle device or a mobile device such as a smartphone, adapted to collect location information on behalf of a driver who has opted-in to such data collection, or as part of an autonomous vehicle system. Route guidance database 104 includes, for a given starting location to a given destination location, recommended routing information that was provided to a requester. Thus, for a particular starting point, which we refer to generally as “point A,” and a particular ending point, “point B,” it is possible to query both the trace database 102 and route guidance database 104 to identify what routes were recommended for that trip based on map data from map database 106, and which routes were actually taken by vehicles traveling from point A to point B.

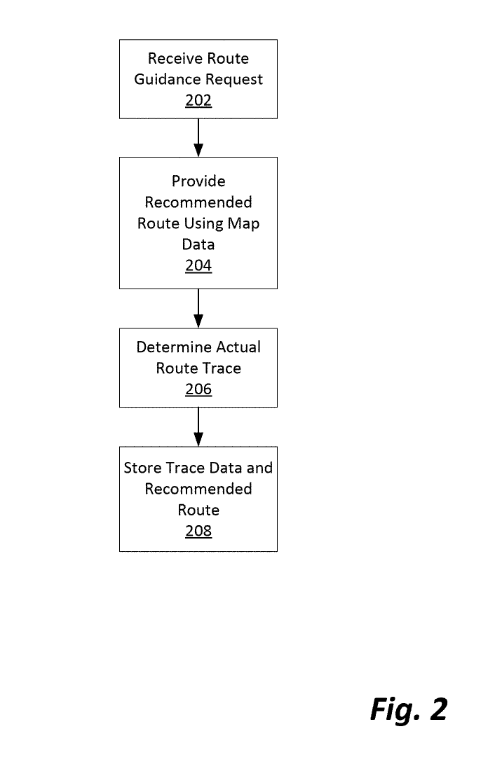

FIG. 2 is a flowchart illustrating steps for providing recommended route guidance to a requester in accordance with one embodiment. Route guidance engine 110 receives 202 a request for route guidance, for example from a driver or autonomous vehicle attempting to navigate from a first location (point A) to a second location (point B). Route guidance engine 110 uses map data from map database 106 to compute and provide 204 a recommended route to the requester. The route actually taken by the vehicle is determined 206 and stored 208 in trace database 102, along with the recommended route. In various embodiments, route guidance engine 110 associates the trace data and recommended route with a common identifier, such as a trip ID, to facilitate subsequent analysis.

While many vehicles travel along the recommended navigation group, others avoid or deviate from the recommended route for at least a portion of their travel. This may be the result of a decision by the driver or autonomous vehicle unrelated to an error in the recommended route guidance, or it may in fact be the result of an error in the recommended route stemming from an error in the underlying map data from map database 106. MAD engine 108 analyzes actual trace data compared to recommended routing data to infer the existence of errors in the map data, and further explained below.

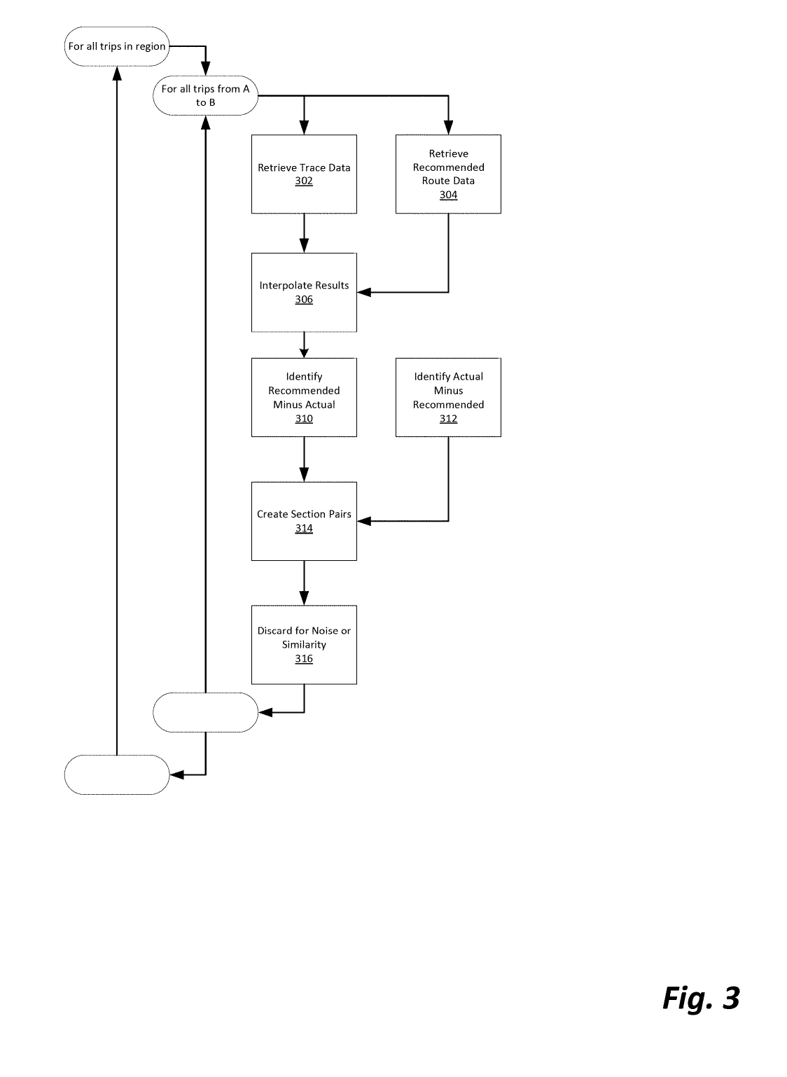

FIG. 3 is a flowchart illustrating a method for identifying anomalies in map data in accordance with one embodiment. We again assume for purposes of this illustration that we are examining a route from a first point, point A, to a second point, point B, within the road network, and that existing map data for the road network including points A and B are stored in map database 106.

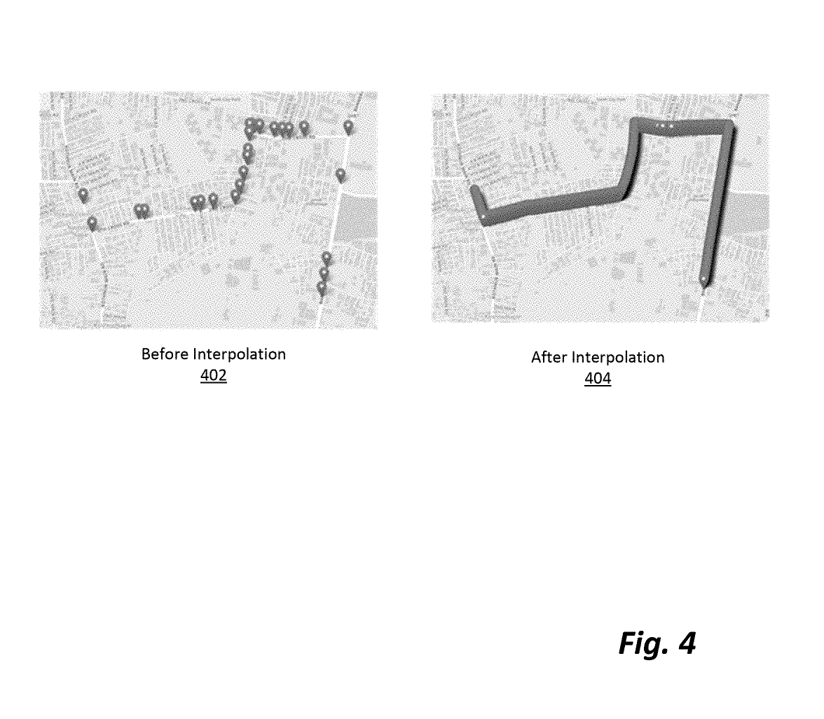

MAD engine 108 retrieves 302 from trace database 102 trace data for a trip that took place from point A to point B. MAD engine 108 also retrieves 304 from route guidance database 104 the suggested route that was suggested for the vehicle to take from point A to point B. Each route polyline is then interpolated 306 in one embodiment so that, for each of the two polylines, its points are within some maximum distance of each other—for example, 5 meters. FIG. 4 illustrates an example of a polyline before 402 and after 404 interpolation.

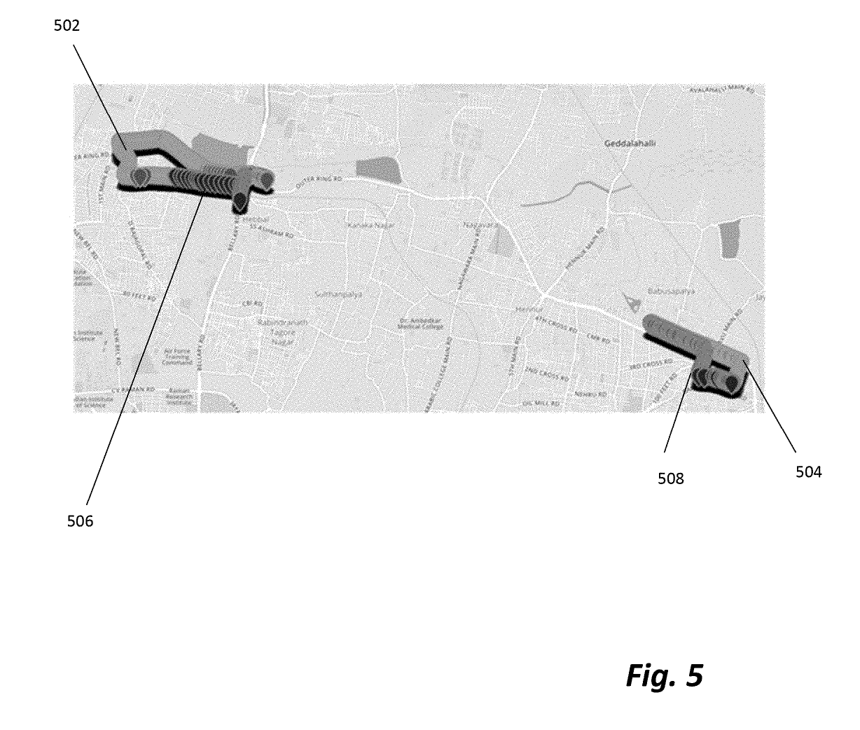

MAD engine 108 then identifies points that are in one polyline but not the other. That is, MAD engine 108 identifies 310 points that are on the recommended route but not on the actual (trace) route, and identifies 312 all points that are on the actual route but not on the recommended route. In one embodiment, to determine whether a point on one polyline is also on the other polyline, MAD engine 108 determines whether there is a point on the other polyline within a threshold distance (e.g., 15 meters) of the point on the first polyline. If so, then the point is considered to be on both polylines; if not, the point is considered to be missing from the other polyline. FIG. 5 illustrates the results of these determinations—points 502 and 504 (in red on the figures as filed) are on the actual (trace) polyline, but not on the recommended route polyline. Points 506 and 508 (in blue on the figures as filed) are on the recommended route polyline, but not on the trace polyline.

As can be seen in FIG. 5, there are now regions of the road network at various areas between A and B where the recommended route is not part of the trace, and the trace is not part of the recommended route. MAD engine 108 creates 314 section pairs for subsequent processing by identifying these regions. In one embodiment, first MAD engine 108 identifies a section as a set of consecutive points on a route which are not part of the other route. Sections from the two routes are paired with each other to form a section pair if the two sections are within a threshold distance of each other, as may be selected by the implementer. For example, points 502 and 506 are pairs within a region, and points 504 and 508 are pairs within a separate region.

MAD engine 108 then checks each section pair to determine whether to discard 316 the pair or consider evaluating it. In one embodiment, pairs are discarded unless at least one of the pair is of at least a first threshold amount in length, and the pair have lengths that differ by a second threshold amount.

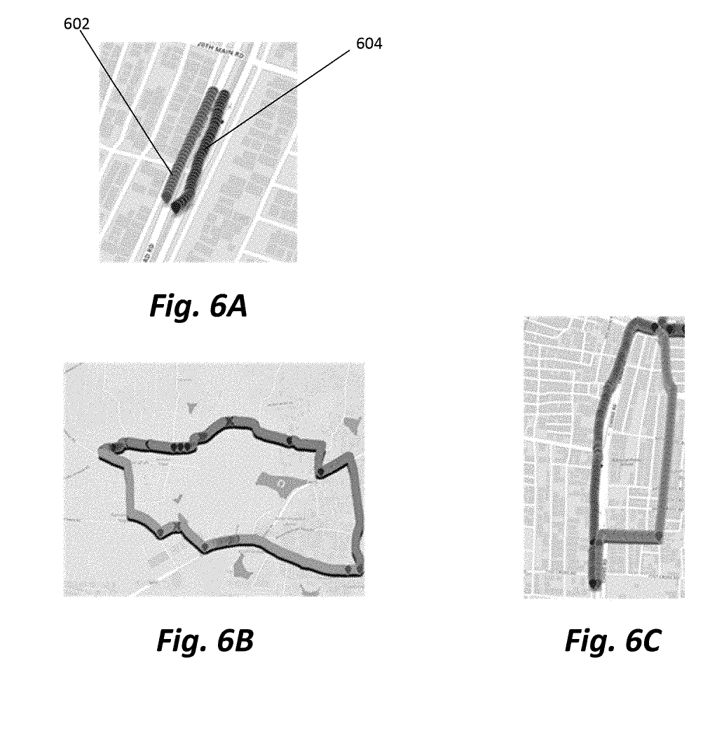

For example, referring to FIG. 6A, segment 602, derived from the trace polyline, and segment 604, from the recommended route polyline, cover too short a distance to be considered significant—the difference in their location could easily be explained by noise in the GPS signal, for example. In one embodiment, MAD engine 108 discards segments if they are shorter than 200 meters in length.

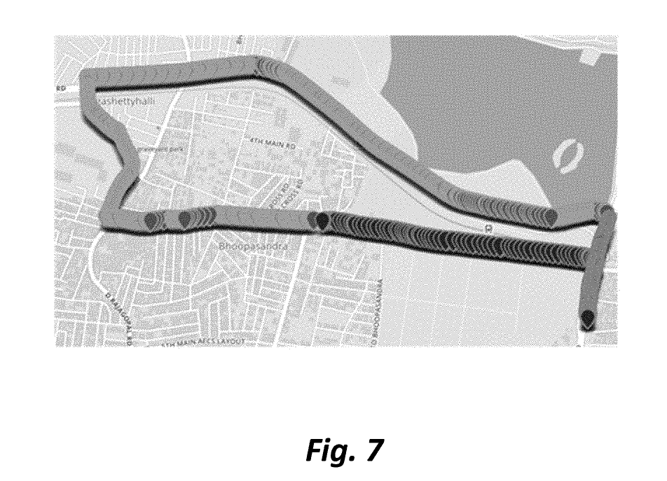

In FIG. 6B, the sections are both too long to be meaningfully analyzed—for example, a driver may simply have chosen to go via a different route for a reason not related to the accuracy of the recommended route. In one embodiment, segments longer than 2 kilometers are discarded by MAD engine 108. And in FIG. 6C, while the segments are of appropriate length, their lengths are too similar to infer significance—perhaps the driver used local knowledge to drive a different route of similar length even though the recommended route would also have sufficed. Thus, in one embodiment, MAD engine 108 discards segments unless the segment from one route is at least 40% greater in length than the other segment. Finally, FIG. 7 illustrates a section pair that is suitable for evaluation—the routes are of sufficient length, but not of the same length.

MAD engine 108 repeats a18 this process for each trip traced and recommended from points A to B over some period of interest—for example, one day. In one embodiment, the process is then repeated across all trips from all origin to all destination points within the map region of interest, e.g., a city. In this example, then, all trips taken over the course of a particular day in a particular city are then be part of the aggregated data set.

In one embodiment, points are represented as latitude/longitude pairs. To allow for measurement error, in one embodiment locations are rounded to four decimal places before aggregation, meaning that two locations that differ only in the fifth decimal place of latitude or longitude will be considered the same point for purposes of analysis.

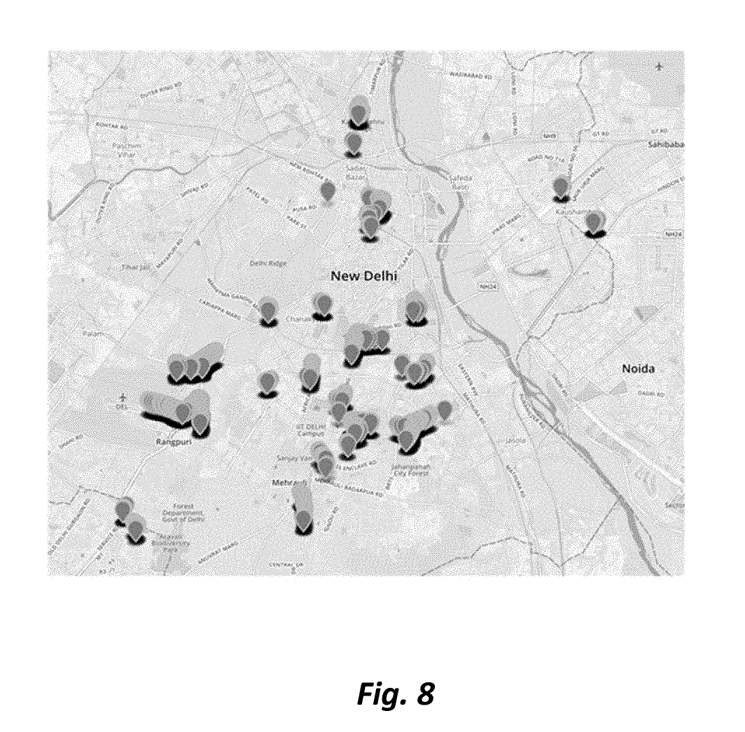

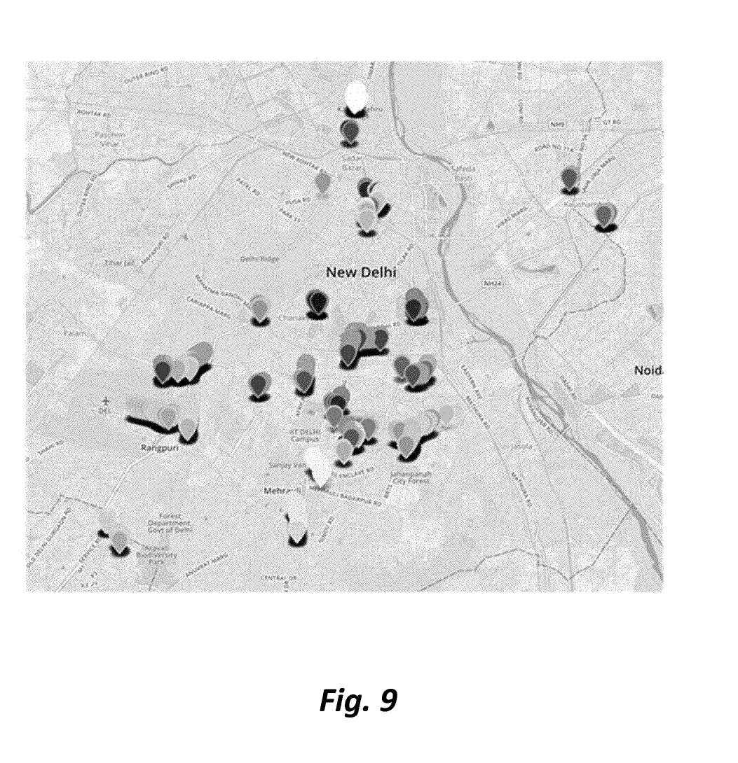

Following the aggregation steps, MAD engine 108 can identify points in map database 106 that are the most frequently occurring in the aggregated data—that is, the points where recommended routes and actual trace data are most frequently inconsistent. FIG. 8 illustrates an example illustration showing points in the city of New Delhi, India, where inconsistencies exist. MAD engine 108 in some embodiments clusters points from the aggregated list based on trips which affect them, as illustrated in FIG. 9. If MAD engine 108 determines that two points are frequently impacted by common trips—that is, a point P frequently occurs in trips from A to B, and another point Q frequently occurs in trips from A to B—then they are included in the same cluster. In one embodiment, MAD engine 108 uses a Jaccard similarity to measure distance between points.

In various embodiments, MAD engine 108 analyzes the clustered results and provides a likely error type. In some embodiments, MAD engine 108 automatically updates data in map database 106 to correct the determined error.

Examples of errors that can be automatically detected by MAD engine 108 include missing road segments, extraneous road segments, wrongly connected road segments, missing turn restrictions, incorrect turn restrictions, missing or incorrect directionality, wrong road connections across lanes, and wrong geometry of roads.

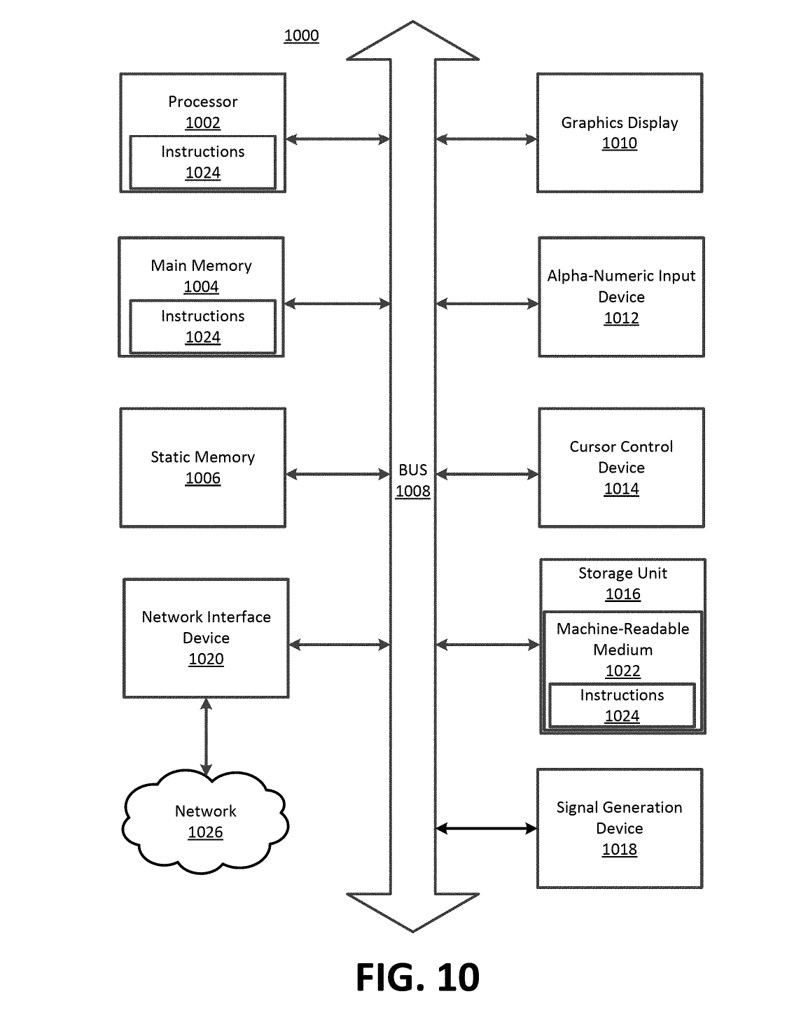

FIG. 10 is a block diagram illustrating components of an example machine for reading and executing instructions from a machine-readable medium. Specifically, FIG. B shows a diagrammatic representation of system 100 in the example form of a computer system 1000. The computer system 1000 can be used to execute instructions 1024 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes one or more processing units (generally processor 1002). The processor 1002 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 1000 also includes a main memory 1004. The computer system may include a storage unit 1016. The processor 1002, memory 1004, and the storage unit 1016 communicate via a bus 1008.

In addition, the computer system 1000 can include a static memory 1006, a graphics display 1010 (e.g., to drive a plasma display panel (PDP), a liquid crystal display (LCD), or a projector). The computer system 1000 may also include alphanumeric input device 1012 (e.g., a keyboard), a cursor control device 1014 (e.g., a mouse, a trackball, a joystick, a motion sensor, or other pointing instrument), a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. For example, the instructions 1024 may include the functionalities of modules of the system 130 described in FIG. 1. The instructions 1024 may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 may be transmitted or received over a network 1026 (e.g., network 120) via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

In addition to the embodiments specifically described above, those of skill in the art will appreciate that the invention may additionally be practiced in other embodiments.

Within this written description, the particular naming of the components, capitalization of terms, the attributes, data structures, or any other programming or structural aspect is not mandatory or significant unless otherwise noted, and the mechanisms that implement the described invention or its features may have different names, formats, or protocols. Further, the system may be implemented via a combination of hardware and software, as described, or entirely in hardware elements. Also, the particular division of functionality between the various system components described here is not mandatory; functions performed by a single module or system component may instead be performed by multiple components, and functions performed by multiple components may instead be performed by a single component. Likewise, the order in which method steps are performed is not mandatory unless otherwise noted or logically required. It should be noted that the process steps and instructions of the present invention could be embodied in software, firmware or hardware, and when embodied in software, could be downloaded to reside on and be operated from different platforms used by real time network operating systems.

Algorithmic descriptions and representations included in this description are understood to be implemented by computer programs. Furthermore, it has also proven convenient at times, to refer to these arrangements of operations as modules or code devices, without loss of generality.

Unless otherwise indicated, discussions utilizing terms such as “selecting” or “computing” or “determining” or the like refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented are not inherently related to any particular computer or other apparatus. Various general-purpose systems may also be used with programs in accordance with the teachings above, or it may prove convenient to construct more specialized apparatus to perform the required method steps. The required structure for a variety of these systems will appear from the description above. In addition, a variety of programming languages may be used to implement the teachings above.

Finally, it should be noted that the language used in the specification Has Bean principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A computer-implemented method for identifying an error in a digital map, the method comprising:
receiving, for a first point and a second point in a road network, a recommended route provided to a vehicle traveling from the first point to the second point;
receiving a trace route describing a route traveled by the vehicle from the first point to the second point;
identifying a first set of points present in the recommended route and absent from the trace route;
identifying a second set of points present in the trace route and absent from the recommended route;
creating a plurality of section pairs, each section pair including a plurality of points from the first set and a plurality of nearby points from the second set;
for each section pair:
determining whether the section pair should be discarded;
responsive to a determination that the section pair should not be discarded:
determining that the points within the section pair represent an error in the map data; and
providing an indication of the determination.

2. The method of claim 1, further comprising automatically correcting the error in the map data.

3. The method of claim 1 wherein the vehicle is an autonomous vehicle.

4. The method of claim 1 wherein the trace route is collected using a mobile device.

5. The method of claim 1 wherein the error in the map data is a missing road segment.

6. The method of claim 1 wherein the error in the map data is an extraneous road segment.

7. The method of claim 1 wherein the error in the map data is a wrongly connected road segment.

8. The method of claim 1 wherein the error in the map data is an incorrect turn restriction.

9. The method of claim 1 wherein the error in the map data is incorrect directionality.

10. The method of claim 1 wherein the error in the map data is incorrect road geometry.

11. A computer program product for identifying an error in a digital map, the computer program product stored on a non-transitory computer-readable medium and including instructions adapted to cause a processor to execute steps comprising:
receiving, for a first point and a second point in a road network, a recommended route provided to a vehicle traveling from the first point to the second point;
receiving a trace route describing a route traveled by the vehicle from the first point to the second point;
identifying a first set of points present in the recommended route and absent from the trace route;
identifying a second set of points present in the trace route and absent from the recommended route;
creating a plurality of section pairs, each section pair including a plurality of points from the first set and a plurality of nearby points from the second set;
for each section pair:
determining whether the section pair should be discarded;
responsive to a determination that the section pair should not be discarded:
determining that the points within the section pair represent an error in the map data; and
providing an indication of the determination.

12. The computer program product of claim 11, further comprising automatically correcting the error in the map data.

13. The computer program product of claim 11 wherein the vehicle is an autonomous vehicle.

14. The computer program product of claim 11 wherein the trace route is collected using a mobile device.

15. The computer program product of claim 11 wherein the error in the map data is a missing road segment.

16. The computer program product of claim 11 wherein the error in the map data is an extraneous road segment.

17. The computer program product of claim 11 wherein the error in the map data is a wrongly connected road segment.

18. The computer program product of claim 11 wherein the error in the map data is an incorrect turn restriction.

19. The computer program product of claim 11 wherein the error in the map data is incorrect directionality.

20. The computer program product of claim 11 wherein the error in the map data is incorrect road geometry.
